(19) United States
(12) Patent Application Publication
(10) Pub. No.: US 2022/0194254 A1
(43) Pub. Date: Jun. 23, 2022

(54) METHODS AND SYSTEMS FOR DETERMINING ELECTRIC VEHICLE ELECTRICITY CONSUMPTION COST

(71) Applicant: Baltimore Gas and Electric Company, Baltimore, MD (US)

(72) Inventors: Divesh Gupta, Baltimore, MD (US); Kristy Fleischmann Groncki, Baltimore, MD (US)

(21) Appl. No.: 17/125,458

(22) Filed: Dec. 17, 2020

(51) Int. Cl. B60L 53/66; B60L 53/64; B60L 53/68; B60L 53/30; B60L 53/67

(52) U.S. Cl. CPC B60L 53/665; B60L 53/64; B60L 53/68; B60L 2240/72; B60L 53/67; B60L 2240/80; B60L 53/305

(57) ABSTRACT

A computing device (e.g., a server, a cloud device, a utility management device, etc.) may receive, from a plurality of charging stations, charging information relating to battery charging for a plurality of electric vehicles (EVs). The computing device may determine different rates for electricity consumption, such as time-of-use rates, and/or the like. The computing device may cause bills, invoices, and/or requests for payments to be generated that indicate different rates for residential electricity consumption and electricity consumption attributed to charging an EV.

### BACKGROUND

Electric vehicle (EV) deployment has steadily increased in recent years. In 2018, the global stock of electric passenger vehicles exceeded 5 million, and the global EV forecast is for a compound annual growth rate of 29 percent achieved over the next ten years. With EVs expected to secure approximately 32 percent of the total market share for new car sales, utility companies and/or service providers require effective and efficient ways to manage load from EV charging in a way that minimizes grid impacts while incentivizing EV through electricity consumption rate plans that adjust according to EV charging behavior. However, utility-owned meters are not configured to delineate EV charging loads from residential electricity consumption to adjust electricity consumption rate plans according to EV charging behavior. Therefore, utility-owned meters are unable to provide time-of-use (TOU) rates for EV charging to encourage off-peak charging thereby minimizing grid impact.

### SUMMARY

It is to be understood that both the following general description and the following detailed description are exemplary and explanatory only and are not restrictive. Methods and systems for determining electric vehicle electricity consumption are described.

Described are methods comprising receiving, by a computing device, charge information associated with an electric vehicle (EV) and location information associated with the EV, determining, based on the location information, a first rate for electricity consumption and a second rate for electricity consumption, determining, based on the charge information, an amount of electricity consumption associated with the EV, and updating an account associated with the EV, wherein the updated account indicates a payment amount for an amount of electricity consumed at the first rate and a payment amount for the amount of electricity consumed associated with the EV at the second rate.

Also described are methods comprising receiving, by a computing device, charge information associated with each electric vehicle (EV) of a plurality of EVs and location information associated with each EV of the plurality of EVs, determining, based on the location information, for each EV of the plurality of EVs, a first rate for electricity consumption and a second rate for electricity consumption, determining, based on the charge information associated with each EV of the plurality of EVs, an amount of electricity consumption associated with the EV, and updating an account associated with each EV of the plurality of EVs, wherein the updated account indicates a payment amount for an amount of electricity consumed at the first rate and a payment amount for the amount of electricity consumed associated with the EV at the second rate.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the methods and systems:

FIG. 1 shows an example system for determining electric vehicle electricity consumption;

FIG. 2 shows an example system for determining electric vehicle electricity consumption;

FIG. 3 shows a flowchart of a method for determining electric vehicle electricity consumption;

FIG. 4 shows a flowchart of a method for determining electric vehicle electricity consumption; and

FIG. 5 shows a flowchart of a method for determining electric vehicle electricity consumption.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

An “electric vehicle” (EV), as used herein, includes any vehicle powered entirely or partially by one or more electric motors electrically coupled to an electric power source (e.g., a battery, etc.). An EV may include battery electric vehicles (BEVs), plug-in hybrid electric vehicles (PHEVs), extended-range electric vehicles (EREVs), and/or the like. The term “vehicle”, as used herein, includes, but is not limited to: cars, trucks, vans, minivans, SUVs, motorcycles, go-karts, scooters, boats, marine vessels, watercraft, airplanes, helicopters, personal and/or single person mobility devices, aircraft, and/or the like.

This detailed description may refer to a given entity performing some action. It should be understood that this language may in some cases mean that a system (e.g., a computer) owned and/or controlled by the given entity is actually performing the action.

A computing device (e.g., a server, a cloud device, a utility management device, etc.) may receive, from a plurality of charge stations, charging information relating to charging a plurality of electric vehicles (EVs). The charging information may be in disparate data formats. The computing device may convert the charging information in disparate formats to a common/shared format. The computing device may determine different rates for electricity consumption, such as time-of-use (TOU) rates and/or the like. The computing device may update user accounts to indicate costs for electricity service at different rates, such as residential electricity consumption rates and TOU rates based on EV charging. The computing device may cause bills and/or requests for payments to be generated that indicate different rates for residential electricity consumption and electricity consumption attributed to charging an EV.

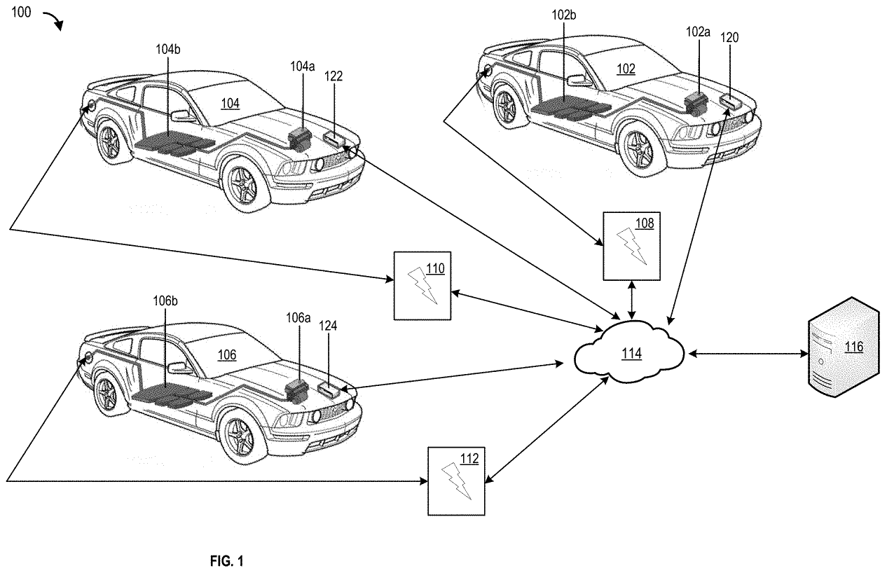

FIG. 1 shows an example system 100 for determining electric vehicle electricity consumption. The system 100 may include a plurality of electric vehicles (EVs), for example, EV 102, EV 104, and EV 106. The EV 102, the EV 104, and the EV 106 may each be configured with an electric motor, for example, electric motors 102a, 104a, and 106a, respectively. The electric motors 102a, 104a, and 106a may include, for example, direct current (DC) series motors, brushless DC motors (BLDCs), permanent magnet synchronous motors (PMSMs), switched reluctance motors (SRMs), and/or any other type of electric motor. The EV 102, the EV 104, and the EV 106 may each be configured with an energy storage module (e.g., a battery, etc.), for example, energy storage modules 102b, 104b, and 106b, respectively. The energy storage modules 102b, 104b, and 106b may include, for example, lithium-ion batteries, nickel-metal hydride batteries, lead-acid batteries, ultracapacitors, and/or any other type of energy storage device/module/component.

The EV 102, the EV 104, and the EV 106 may connect to and/or be in communication with a charging station (e.g., an electric recharging device, a charging point, a charge point, an electronic charging station (ECS), electric vehicle supply equipment (EVSE), etc.) located, for example, at a residence/home. For example, the EV 102 may connect to and/or be in communication with a charging station 108, the EV 104 may connect to and/or be in communication with a charging station 110, and the EV 106 may connect to and/or be in communication with a charging station 112. The EV 102, the EV 104, and the EV 106 may connect to the charging station 108, the charging station 110, and the charging station 112, respectively, via a charging link/cable and also be in communication with the charging station 108, the charging station 110, and the charging station 112, respectively, via a wired (e.g., the charging link/cable, etc.) and/or wireless (e.g., inductive charging, etc.) connection and/or communication link.

The charging stations (e.g., the charging station 108, the charging station 110, and the charging station 112, etc.) may provide/supply electric energy for the recharging/replenishing energy storage modules (e.g., the energy storage modules 102b, 104b, and 106b, etc.) and/or energy storage devices. The charging stations (e.g., the charging station 108, the charging station 110, and the charging station 112, etc.) may support one or more charging modes and/or configurations connected to and/or configured with a power grid, such as a domestic socket and extension cord connection via standard socket-outlets, a domestic socket and cable with a protection device, a specific (e.g, manufactured specific, device-specific, etc.) socket on a dedicated circuit, a direct current (DC) connection enabling fast recharging, and/or the like. The charging stations (e.g., the charging station 108, the charging station 110, and the charging station 112, etc.) may support alternating current (AC) charging and/or DC charging.

The charging stations (e.g., the charging station 108, the charging station 110, and the charging station 112, etc.) may receive/send data/information from/to the EVs (e.g., the EV 102, the EV 104, the EV 106, etc.). For example, the charging station 108 may communicate with a computing device 120 (e.g, a telematics device, an electronic control device, etc.) configured with the EV 102, the charging station 110 may communicate with a computing device 122 (e.g, a telematics device, an electronic control device, etc.) configured with the EV 106, and the charging station 112 may communicate with a computing device 124 (e.g, a telematics device, an electronic control device, etc.) configured with the EV 108 to receive/send data/information from/to the respective EVs. For example, the computing device (e.g., the computing device 120, the computing device 122, the computing device 124, etc.) may communicate with the charging station (e.g., the charging station 108, the charging station 110, and the charging station 112, etc.) whenever the EV (e.g., the EV 102, the EV 104, the EV 106, etc.) connects to the charging station to recharge an energy storage module (e.g., the energy storage module 102b, the energy storage module 104b, the energy storage module 106b, etc.), when the EV disconnects from the charging station once the energy storage module is recharged, during periodic intervals, and/or based on any other occurrence/event associated with the EV and/or the charging station.

The charging stations (e.g., the charging station 108, the charging station 110, and the charging station 112, etc.) may communicate charging information to/from the EVs (e.g., the EV 102, the EV 104, the EV 106, etc.). Charging information may include any data/information related to and/or associated with any component (e.g., an engine, an on-board computer, an energy module, etc.) and/or system (e.g., an electrical system, a control/operating system, a recharge system, a telemetry system, etc.) of an EV (e.g., the EV 102, the EV 104, the EV 106, etc.).

The charging stations (e.g., the charging station 108, the charging station 110, the charging station 112, etc.) may communicate data/information associated with the EVs (e.g., the EV 102, the EV 104, the EV 106, etc.), such as charging information, to a computing device 116 (e.g., a server, a cloud device, a utility management device, etc.) via a network 114 (e.g., a wireless network, a cellular network, a packet-switched network, etc.).

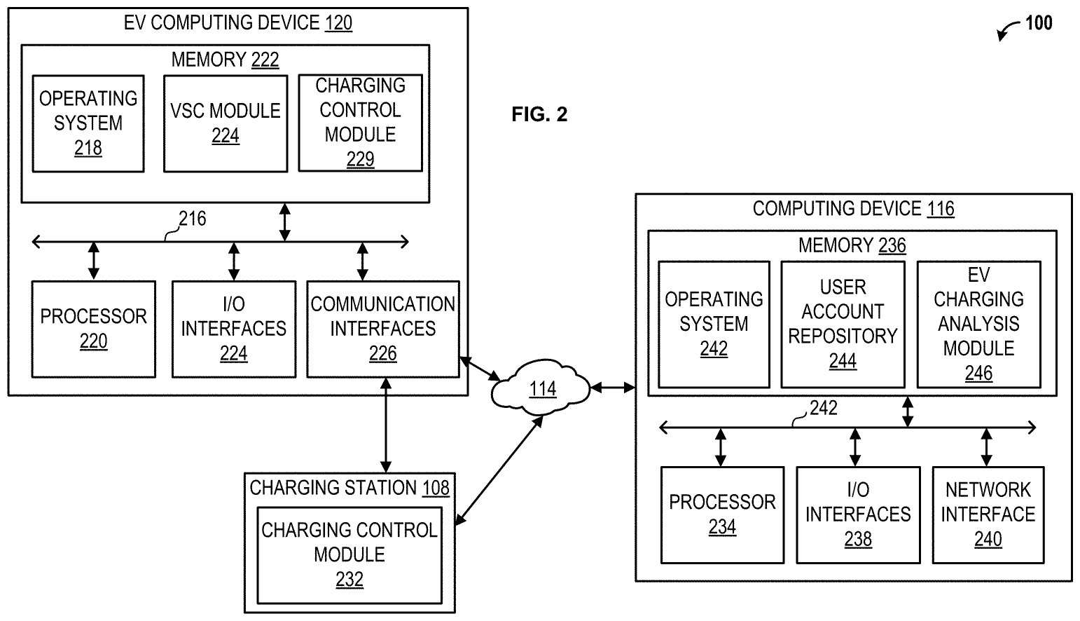

FIG. 2 shows an example block diagram of a portion of the system 100 for determining electric vehicle electricity consumption. FIG. 2 include the computing device 120, the charging station 108, and the computing device 116. Although not shown in FIG. 2, the computing devices 122 and 124 may be configured as and/or operate similarly to the computing device 120, and the charging stations 110 and 112 may be configured as and/or operate similarly to the charging station 108.

The computing device 120 (e.g, a telematics device, an electronic control device, etc.) may be in communication with one or more components of the EV 102, such as the electric motors 102a, the energy storage module 102b, and/or any other component of the EV 102.

The computing device 120 may be a digital computer that, in terms of hardware architecture, generally includes a processor 220, memory 222, input/output (I/O) interfaces 224, and communication interfaces 226. These components (220, 222, 224, and 226) are communicatively coupled via a local interface 216. The local interface 216 may be, for example, but not limited to, one or more buses or other wired or wireless connections, as is known in the art. The local interface 216 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 220 may be a hardware device for executing software, particularly that stored in the memory 222. The processor 220 may be any custom made or commercially available processor, a central processing unit (CPU), an auxiliary processor among several processors associated with the computing device 120, a semiconductor-based microprocessor (in the form of a microchip or chipset), or generally any device for executing software instructions. When an EV and/or the computing device 120 is in operation, the processor 220 may execute software stored within the memory 222, to communicate data to and from the memory 222, and to generally control operations of the computing device 120 pursuant to the software.

The computing device 120 may include I/O interfaces 224. The I/O interfaces 224 may be used to receive user input from, and/or for providing system output to, one or more devices or components. Input may be provided via, for example, a keyboard, a touchscreen, a voice-activated control, and/or the like. Output may be provided via one or more audio units (e.g., speakers, etc.) and/or a display (e.g., a head unit, a display stack, a heads-up display). The I/O interfaces 224 may include, for example, a serial port, a parallel port, a Small Computer System Interface (SCSI), an infrared (IR) interface, a radio frequency (RF) interface, and/or a universal serial bus (USB) interface.

The communication interfaces 226 may be used to transmit and receive data/information from the charging station 108 and/or the computing device 116. The communication interfaces 226 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The communication interfaces 226 may include address, control, and/or data connections to enable appropriate communications on the network 114 (e.g., a wireless network, a cellular network, a packet-switched network, etc.). The communication interfaces 206 may include one or more charging links to connect the EV and/or the computing device 120 to the charging station 108. The one or more charging links may support single-phase vehicle couplers, single-phase and three-phase vehicle couplers, single-phase and three-phase vehicle couplers equipped with safety shutters, fast charge couplers, and/or the like.

The memory 222 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory 222 may incorporate electronic, magnetic, optical, and/or other types of storage media. Note that the memory 222 may have a distributed architecture, where various components are situated remote from one another, but may be accessed by the processor 220.

The memory 222 may include one or more software programs, each of which comprises an ordered listing of executable instructions for implementing logical functions. In the example of FIG. 2, the software in the memory 222 may include an operating system 218, vehicle systems and components (VSC) unit 222, and charging control module 229. The operating system 218 essentially controls the execution of other computer programs and provides scheduling, input-output control, file and data management, memory management, and communication control, and related services.

For purposes of illustration, application programs and other executable program components such as the operating system 218 are shown herein as discrete blocks, although it is recognized that such programs and components may reside at various times in different storage components of the computing device 120. An implementation of the system 100 may be stored on or transmitted across some form of computer-readable media. Any of the disclosed methods may be performed by computer readable instructions embodied on computer-readable media. Computer-readable media may be any available media that may be accessed by a computer. By way of example and not meant to be limiting, computer-readable media may comprise “computer storage media” and “communications media.” “Computer storage media” may comprise volatile and non-volatile, removable and non-removable media implemented in any methods or technology for storage of information such as computer-readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

The VSC unit 222 may communicate with systems and components of the EV 102, such as the electric motor 102a and the energy storage module 102b. The VSC unit 222 may determine a state (e.g., e.g., an operational state, a communication state, etc.), an operation, a mode, a configuration, and/or the like associated with the systems and components of the EV 102, such as the electric 102a and the energy storage module 102b.

The VSC unit may communicate and/or exchange data/information with the charging control module 229. The charging control module 229 may communicate and/or exchange information with the charging station 108. For example, the charging station 108 may include a charging control module 232 that communicates and/or exchanges information with the charging station 108, such as charging information. The charging control module 229 and/or the charging control module 232 may determine and/or store charging information, for example, whenever the EV 102 connects to and/or receives a charge (e.g., electricity, power, energy, etc.) from the charging station 108. The charging control module 229 and/or the charging control module 232 may determine and/or store charging information to facilitate time-varying electricity rates and/or pricing, such as Time of Use (TOU), Critical Peak Pricing (CPP), Real-Time Pricing (RTP), and/or the like for residences and/or locations associated with the charging station and/or EV. Charging information may be used, for example, by a utility service provider, to determine the cost and/or charge for electrical usage (consumption) dependent upon the time of use to incentivize off-peak EV charging behavior.

Charging information may include, for example, data/information related to the systems and components of the EV 102 such as the electric motor 102a, as well as data/information related to the recharging of the energy storage module 102b and the charging station 108. Charging information may include, for example, ignition status (e.g., ON/OFF), location information (e.g., GPS coordinates, an address associated with an EV and/or charging station, etc.), temporal charging information (e.g., a charge start time/date, a charge end time/date), a time of use (TOU) rate, a charging energy source information (e.g., charging station manufacture details, communication protocols associated with a charging station, data format and/or encryption/decryption information associated with a charging station, etc.), a charge amount, a current state-of-charge (SOC), a SOC at the charge start time, a SOC at the charge end time, a utility area/region, a battery type, a charger type, charger timer usage, an ignition ON time, an ignition OFF time, and/or the like.

Charging information may be sent to the computing device 116 for analysis. The computing device 116 may include a processor 234, memory 236, input/output (I/O) interfaces 238, and a network interface 240. These components (234, 236, 238, and 240) are communicatively coupled via a local interface 242. The local interface 242 may be, for example, but not limited to, one or more buses or other wired or wireless connections, as is known in the art. The local interface 242 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 234 may be a hardware device for executing software, particularly that stored in the memory 236. The processor 234 may facilitate electric vehicle charging analysis, for example, to determine electric vehicle electricity consumption and related electricity consumption rates. The processor 234 may be any custom made or commercially available processor, a central processing unit (CPU), an auxiliary processor among several processors associated with the computing device 116, a semiconductor-based microprocessor (in the form of a microchip or chipset), or generally any device for executing software instructions. When computing device 116 is in operation, the processor 234 may execute software stored within the memory 236, to communicate data to and from the memory 236, and to generally control operations of the computing device 116 pursuant to the software.

The computing device 116 may include I/O interfaces 238. The I/O interfaces 238 may be used to receive user input from, and/or for providing system output to, one or more devices or components. Input may be provided via, for example, a keyboard, a touchscreen, a voice-activated control, and/or the like. Output may be provided via one or more audio units (e.g., speakers, etc.) and/or a display. The I/O interfaces 224 may include, for example, a serial port, a parallel port, a Small Computer System Interface (SCSI), an infrared (IR) interface, a radio frequency (RF) interface, and/or a universal serial bus (USB) interface.

A network interface 240 may be used to transmit and receive data/information from the charging station 108 and/or the computing device 120. The network interface 240 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 240 may include address, control, and/or data connections to enable appropriate communications on the network 114.

The memory 236 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory 236 may incorporate electronic, magnetic, optical, and/or other types of storage media. Note that the memory 236 may have a distributed architecture, where various components are situated remote from one another, but may be accessed by the processor 234.

The memory 236 may include one or more software programs, each of which comprises an ordered listing of executable instructions for implementing logical functions. In the example of FIG. 2, the software in the memory 236 may include an operating system 242, a user account repository 244, and EV charging analysis module 246. The operating system 242 essentially controls the execution of other computer programs and provides scheduling, input-output control, file and data management, memory management, and communication control, and related services.

For purposes of illustration, application programs and other executable program components such as the operating system 242 are shown herein as discrete blocks, although it is recognized that such programs and components may reside at various times in different storage components of the computing device 116. An implementation of the system 100 may be stored on or transmitted across some form of computer-readable media. Any of the disclosed methods may be performed by computer readable instructions embodied on computer-readable media. Computer-readable media may be any available media that may be accessed by a computer. By way of example and not meant to be limiting, computer-readable media may comprise “computer storage media” and “communications media.” “Computer storage media” may comprise volatile and non-volatile, removable and non-removable media implemented in any methods or technology for storage of information such as computer-readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

The user account repository 244 may store data/information for a plurality of users and/or devices associated with the user such as data/information associated with utility services, residence/service locations, EVs, charge stations, and/or the like. The data/information for the plurality of users and/or devices may be stored and/or associated with a plurality of user accounts. The plurality of user accounts may include utility (e.g., electricity, etc.) consumption/usage data/information and any related cost, payment, and/or bill information.

Referring to FIGS. 1-2, charging information may be sent, for example, to the computing device 116. The charging stations 108, 110, and 112 may each send charging information to the computing device 116. The charging stations 108, 110, and 112 may send charging information to the computing device 116 at random intervals, at periodic and/or scheduled intervals, and/or based on an event/occurrence, such as based on the operation of an EV (e.g., an ignition ON signal, an ignition OFF signal, an ignition ON/OFF cycle, etc.) and/or a determination that a charging link between an EV and a charging station is established and/or terminated.

The computing device 116 may store and/or analyze charging information received from the charging stations 108, 110, and 112, and/or the EVs 102, 104, and 106. For example, the computing device 116 may use the EV charging analysis module 246 to analyze charging information and/or the user account repository 244 to store charging information and/or data/information determined from and/or associated with charging information. Charging information received from the charging stations 108, 110, and 112, and/or the EVs 102, 104, and 106 may include identification information, such as charging station (e.g., the charging stations 108, 110, and 112, etc.) identification information, EV (e.g., the EVs 102, 104, and 106, etc.) identification information, location identification information, user (e.g., a driver of an EV, etc.) identification information, and/or the like.

Charging information received from the charging stations 108, 110, and 112, and/or the EVs 102, 104, and 106 may be in a plurality of different formats, such as manufacturer-specific data formats, and/or the like. The charging station 116 may use the EV charging analysis module 246 to convert charging information received in disparate formats to a common/shared format, for example, based on a conversion protocol and/or process. The charging analysis module 246 may determine unique-information within charging information received from the charging stations 108, 110, and 112, and/or the EVs 102, 104, and 106 that identifies key/important information, such as electricity consumption values (e.g., measured in kilowatts per hour, etc.) and/or times (e.g., charging start/end time/period, etc.). For example, the charging analysis module 246 may determine identification information and/or other unique information from a header of a packet(s) containing charging information from the charging station 108 that indicates that the charging station node is an X-108 is a type XYZ charging station manufactured by company A and/or that the EV 102 is a type A EV manufactured by company B. The determined identification information and/or other unique information may be applied to a data repository and/or look-up table to convert the data format of the charging information into a data format of and/or used by the computing device 116. Charging information in the data format of and/or used by the computing device 116 may be further analyzed.

The computing device 116, for example via the charging analysis module 246, may analyze charging information to determine temporal-based and/or consumption-based rates for utility (e.g., electricity, power, energy, etc.) usage. For example, the computing device 116 may determine time-of-use (TOU) rates for charging and/or recharging utility consumption for any EV (e.g., the EVs 102, 104, and 106, etc.) and/or charging station (e.g, the charging stations 108, 110, and 112, etc.) based on a time-of-day and/or the location electricity is provided, delivered, and/or serviced. TOU rates can be fixed based on the time-of-day and/or the location, for example, a residence associated with any EV (e.g., the EVs 102, 104, and 106, etc.) and/or charging station (e.g, the charging stations 108, 110, and 112, etc.). TOU rates can be dynamic based on a current supply-demand situation (e.g., grid load, etc.). TOU rates may be lower during off-peak hours than on-peak hours. TOU rates may have more than one tier, for example, on-peak, off-peak, super off-peak, night and weekend, and/or the like.

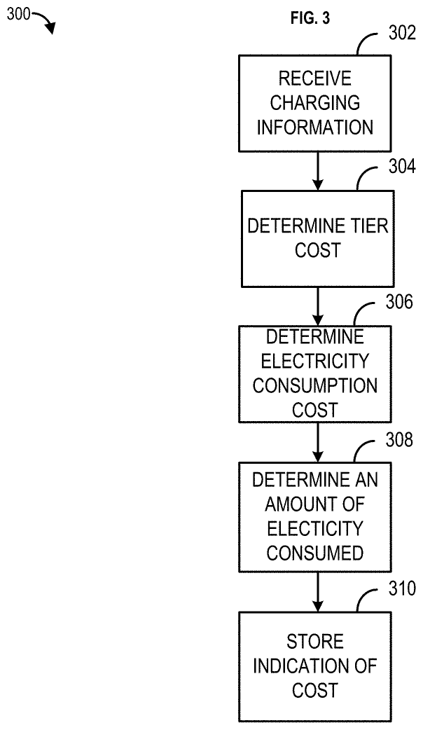

FIG. 3 is an example flowchart for determining electric vehicle electricity consumption. At 302, a computing device (e.g., a server, a cloud device, a utility management device, the computing device 116, etc.) may receive charging information from a charging station (e.g, the charging stations 108, 110, and 112, etc.) and/or an EV (e.g., the EVs 102, 104, and 106, etc.). The computing device may receive charging information from the charging station and/or EV at random intervals, at periodic and/or scheduled intervals, and/or the like.

At 304, the computing device may determine a tiered cost for electricity consumption, for example, on-peak, off-peak, super off-peak, night and weekend, and/or the like. For example, the computing device may be owned and/or associated with a utility service provider. The utility service provider and/or a utility service provider device may send/provide data/information associated with tier rates of electricity consumption to the computing device.

At 306, the computing device may determine a rate/cost for electricity (and/or any other utility/resource, etc.) consumption. For example, the computing device may determine a utility area based on the location information associated with any EV (e.g., the EVs 102, 104, and 106, etc.) and/or charging station (e.g, the charging stations 108, 110, and 112, etc). The computing device, based on the charging information (e.g., charging start/stop times) and the utility service area, may determine a TOU rate and determine whether the EV is charging during an on-peak or off-peak time. The computing device 116 may determine the peak or off-peak time and associated rate/pricing based on location information, a charge start time/date, a charge end time/date, and/or a charge amount.

At 308, the computing device may determine an amount of electricity (and/or any other utility/resource, etc.) consumption. The computing device 116 may determine an amount of electricity consumption that occurs at a location/residence and how much of the amount is attributed to an EV (e.g., the EVs 102, 104, and 106, etc.). The computing device may be in communication with one or more meters (e.g, electric meters, smart meters, etc.) that provide data/information regarding an amount of electricity (and/or any other utility/resource, etc.) consumed by a residence/location. For example, the computing device may determine an amount of electricity consumption for a location/residence connected to and/or receiving power from a power grid, substation, powerline, a renewable energy source, and/or the like. The computing device may determine an amount of the electricity consumption for the location/residence that is attributed to an EV. The computing device may determine the amount of electricity consumption for the location/residence that is attributed to the EV by subtracting an amount of electricity consumption indicated by charging information received from the charging station and/or EV from the amount of electricity consumption for the location/residence. The computing device may determine the amount of electricity consumption for the location/residence that is attributed to the EV by any method/means.

At 310, the computing device may store/log and indication of cost. The indication of the cost may be an indication of cost for the amount of electricity consumption for the location/residence that is attributed to the EV based on the TOU rate determined at step 306.

Referring to FIGS. 1-2, the computing device 116 may determine, based on location and/or charging information received, for example, from an EV (e.g., the EVs 102, 104, and 106, etc.) and/or charging station (e.g, the charging stations 108, 110, and 112, etc), a user account associated with the EV. The computing device 116, based on the determined TOU rate, may cause an update to the user account associated with the EV, to indicate a payment amount for an amount of electricity consumption at the location/residence at a rate (e.g., utility market rate, etc.) and a payment amount for the amount of electricity consumption associated with the EV at the TOU rate. The computing device 116 may cause an indication of the payment amount for the amount of electricity consumption at the location/residence at the rate (e.g., utility market rate, etc.) and a payment amount for the amount of electricity consumption associated with the EV at the TOU rate to be sent to the EV, the charging station, and/or the location/residence.

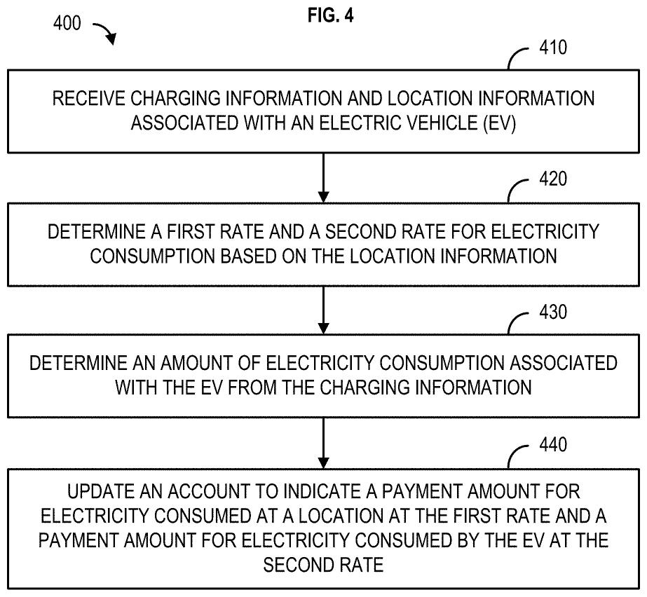

In an embodiment, illustrated in FIG. 4, the devices/component described herein can be configured to perform a method 400 comprising, at 410, receiving, by a computing device (e.g., a server, a cloud device, a utility management device, the computing device 116, etc.), charging information associated with an electric vehicle (EV) (e.g., the EVs 102, 104, and 106, etc.) and location information associated with the EV. Receiving the charging information may include receiving the charging information from a charging station (e.g, the charging stations 108, 110, and 112, etc) associated with a location indicated by the location information.

Charging information may include, for example, data/information related to the systems and components of the EV such as an electric motor, as well as data/information related to the recharging of a battery and/or the charging station. Charging information may include, for example, ignition status (e.g., ON/OFF), location information (e.g., GPS coordinates, an address associated with an EV and/or charging station, etc.), temporal charging information (e.g., a charge start time/date, a charge end time/date), a time of use (TOU) rate, a charging energy source information (e.g., charging station manufacture details, communication protocols associated with a charging station, data format and/or encryption/decryption information associated with a charging station, etc.), a charge amount, a current state-of-charge (SOC), a SOC at the charge start time, a SOC at the charge end time, a utility area/region, a battery type, a charger type, charger timer usage, an ignition ON time, an ignition OFF time, and/or the like.

The charging information may be in a first format, such as a format specific to and/or associated with a manufacturer and/or the like of the charging station and/or EV. The computing device may convert, for example, based on a conversion protocol, the first format to a second format. The second format may be specific to and/or associated with the computing device, a utility service provider, billing information, and/or the like.

At 420, determining, based on the location information, a first rate for electricity consumption and a second rate for electricity consumption. The first rate may be a normal rate, a commercial rate, a service provider rate, a local rate, and/or the like for electricity consumption. The second rate may include a prorated rate for electricity consumption associated with EVs, such as a TOU rate and/or the like. The computing device may determine a rate/cost for electricity (and/or any other utility/resource, etc.) consumption. For example, the computing device may determine a utility area based on the location information associated with an EV (e.g., the EVs 102, 104, and 106, etc.) and/or charging station (e.g, the charging stations 108, 110, and 112, etc). The computing device, based on the charging information (e.g., charging start/stop times) and the utility service area, may determine a TOU rate and determine whether the EV is charging during an on-peak or off-peak time. The computing device may determine the peak or off-peak time and associated rate/pricing based on location information, a charge start time/date, a charge end time/date, and/or a charge amount.

At 430, determining, based on the charging information, an amount of electricity consumption associated with the EV. The computing device may determine an amount of electricity consumption that occurs at a location/residence and how much of the amount is attributed to the EV (e.g., the EVs 102, 104, and 106, etc.). The computing device may be in communication with one or more meters (e.g, electric meters, smart meters, etc.) that provide data/information regarding an amount of electricity (and/or any other utility/resource, etc.) consumed by a residence/location. For example, the computing device may determine an amount of electricity consumption for a location/residence connected to and/or receiving power from a power grid, substation, powerline, a renewable energy source, and/or the like.

At 440, updating an account associated with the EV, wherein the updated account indicates a payment amount for an amount of electricity consumed at the first rate and a payment amount for the amount of electricity consumed associated with the EV at the second rate. For example, the computing device, based on the second rate (e.g., a TOU rate, etc.), may cause an update to the user account associated with the EV, to indicate a payment amount for the amount of electricity consumption at the location/residence at the first rate and a payment amount for the amount of electricity consumption associated with the EV at the second rate. The computing device may cause an indication of the payment amount for the amount of electricity consumption at the location/residence at the first rate and a payment amount for the amount of electricity consumption associated with the EV at the second rate to be sent to the EV, the charging station, and/or the location/residence.

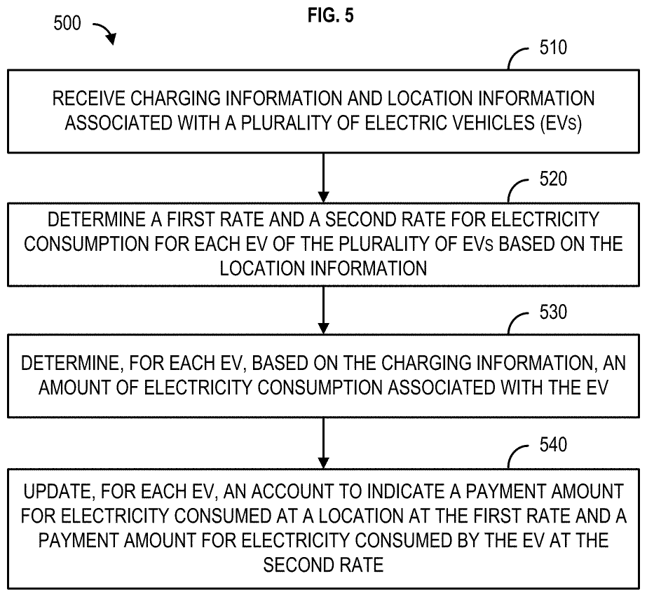

In an embodiment, illustrated in FIG. 5, the devices/component described herein can be configured to perform a method 500 comprising, at 510, receiving, by a computing device (e.g., a server, a cloud device, a utility management device, the computing device 116, etc.), charging information associated with each electric vehicle (EV) (e.g., the EVs 102, 104, and 106, etc.) of a plurality of EVs and location information associated with each EV of the plurality of EVs. Receiving the charging information may include receiving the charging information from a plurality of charging stations (e.g, the charging stations 108, 110, and 112, etc). Each charging station of the plurality of charging stations may be associated with a location of a plurality of locations indicated by the location information.

Charging information may include, for example, data/information related to the systems and components of an EV such as an electric motor, as well as data/information related to the recharging of a battery and/or the charging station. Charging information may include, for example, ignition status (e.g., ON/OFF), location information (e.g., GPS coordinates, an address associated with an EV and/or charging station, etc.), temporal charging information (e.g., a charge start time/date, a charge end time/date), a time of use (TOU) rate, a charging energy source information (e.g., charging station manufacture details, communication protocols associated with a charging station, data format and/or encryption/decryption information associated with a charging station, etc.), a charge amount, a current state-of-charge (SOC), a SOC at the charge start time, a SOC at the charge end time, a utility area/region, a battery type, a charger type, charger timer usage, an ignition ON time, an ignition OFF time, and/or the like.

Charging information may be in a first format, such as a format specific to and/or associated with a manufacturer and/or the like of a charging station of the plurality of charging stations and/or an EV of the plurality of EVs. The computing device may convert, for example, based on a conversion protocol, the first format to a second format. The second format may be specific to and/or associated with the computing device, a utility service provider, billing information, and/or the like.

At 520, determining, based on the location information, for each EV of the plurality of EVs, a first rate for electricity consumption and a second rate for electricity consumption. The first rate may be a normal rate, a commercial rate, a service provider rate, a local rate, and/or the like for electricity consumption. The second rate may include a prorated rate for electricity consumption associated with EVs, such as a TOU rate and/or the like. The computing device may determine a rate/cost for electricity (and/or any other utility/resource, etc.) consumption. For example, the computing device may determine a utility area based on the location information associated with each EV (e.g., the EVs 102, 104, and 106, etc.) of th plurality of EVs and/or each charging station (e.g, the charging stations 108, 110, and 112, etc) of the plurality of charging stations. The computing device, based on the charging information (e.g., charging start/stop times) and the utility service area, may determine a TOU rate and determine whether an EV is charging during an on-peak or off-peak time. The computing device may determine the peak or off-peak time and associated rate/pricing based on location information, a charge start time/date, a charge end time/date, and/or a charge amount.

At 530, determining, based on the charging information associated with each EV of the plurality of EVs, an amount of electricity consumption associated with the EV. The computing device may determine an amount of electricity consumption that occurs at each location/residence indicated by the location information and how much of the amount is attributed to an EV (e.g., the EVs 102, 104, and 106, etc.) of the plurality of EVs. The computing device may be in communication with one or more meters (e.g, electric meters, smart meters, etc.) that provide data/information regarding an amount of electricity (and/or any other utility/resource, etc.) consumed by a residence/location. For example, the computing device may determine an amount of electricity consumption for a location/residence connected to and/or receiving power from a power grid, substation, powerline, a renewable energy source, and/or the like.

At 540, updating an account associated with each EV of the plurality of EVs, wherein the updated account indicates a payment amount for an amount of electricity consumed at the first rate and a payment amount for the amount of electricity consumed associated with the EV at the second rate. For example, the computing device, based on the second rate (e.g., a TOU rate, etc.), may cause an update to a user account associated with an EV to indicate a payment amount for the amount of electricity consumption at the location/residence at the first rate and a payment amount for the amount of electricity consumption associated with the EV at the second rate. The computing device may cause an indication of the payment amount for the amount of electricity consumption at the location/residence at the first rate and a payment amount for the amount of electricity consumption associated with the EV at the second rate to be sent to the EV, the charging station, and/or the location/residence.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
receiving, by a computing device, charging information associated with an electric vehicle (EV) and location information associated with the EV;
determining, based on the location information, a first rate for electricity consumption and a second rate for electricity consumption;
determining, based on the charging information, an amount of electricity consumption associated with the EV; and
updating an account associated with the EV, wherein the updated account indicates a payment amount for an amount of electricity consumed at the first rate and a payment amount for the amount of electricity consumed associated with the EV at the second rate.

2. The method of claim 1, wherein receiving the charging information comprises receiving the charging information from a charging station associated with a location indicated by the location information.

3. The method of claim 1, wherein the charging information is in a first format, the method further comprising converting, based on a conversion protocol, the first format to a second format.

4. The method of claim 3, wherein the first format is associated with a manufacturer of at least one of a charging station associated with a location indicated by the location information or the EV.

5. The method of claim 3, wherein the second format is associated with at least one of a utility service provider or billing information.

6. The method of claim 1, wherein the second rate comprises a prorated rate for electricity consumption associated with EVs.

7. The method of claim 1, wherein the charging information further indicates timing information associated with the amount of electricity consumption associated with the EV, wherein the method further comprises adjusting, based on the timing information, the second rate.

8. The method of claim 7, wherein the adjusted rate is lower than the second rate when the timing information indicates an off-peak time for the amount of electricity consumption associated with the EV.

9. The method of claim 1, further comprising sending a request for the payment amount for the amount of electricity consumed at the first rate and the payment amount for the amount of electricity consumed associated with the EV at the second rate.

10. A method comprising:
receiving, by a computing device, charging information associated with each electric vehicle (EV) of a plurality of EVs and location information associated with each EV of the plurality of EVs;
determining, based on the location information, for each EV of the plurality of EVs, a first rate for electricity consumption and a second rate for electricity consumption;
determining, based on the charging information associated with each EV of the plurality of EVs, an amount of electricity consumption associated with the EV; and
updating an account associated with each EV of the plurality of EVs, wherein the updated account indicates a payment amount for an amount of electricity consumed at the first rate and a payment amount for the amount of electricity consumed associated with the EV at the second rate.

11. The method of claim 10, wherein receiving the charging information associated with each EV of the plurality of EVs comprises receiving the charging information from a plurality of charging stations, wherein each charging station of the plurality of charging stations is associated with a location of a plurality of locations indicated by the location information.

12. The method of claim 10, wherein the charging information associated with each EV of the plurality of EVs is in a format associated with a manufacturer of a charging station of a plurality of charging stations, wherein each charging station of the plurality of charging stations is associated with a location of a plurality of locations indicated by the location information, the method further comprising converting, for the charging information associated with each EV of the plurality of EVs, based on a conversion protocol, the format associated with the manufacturer to a second format.

13. The method of claim 12, wherein the second format is associated with at least one of a utility service provider or billing information.

14. The method of claim 10, wherein the second rate comprises a prorated rate for electricity consumption associated with EVs.

15. The method of claim 10, wherein the charging information associated with each EV of the plurality of EVs further indicates timing information associated with the amount of electricity consumption associated with the EV, wherein the method further comprises adjusting, for each EV of the plurality of EVs, based on the timing information, the second rate.

16. The method of claim 15, wherein, for each EV of the plurality of EVs, the adjusted rate is lower than the second rate when the timing information indicates an off-peak time for the amount of electricity consumption associated with the EV.

17. The method of claim 10, further comprising sending, to a device associated with each EV of the plurality of EVs, a request for the payment amount for the amount of electricity consumed at the first rate and the payment amount for the amount of electricity consumed associated with the EV at the second rate.

18. An apparatus, comprising:
one or more processors; and
memory storing processor-executable instructions that, when executed by the one or more processors, cause the apparatus to:
receive, by a computing device, charging information associated with each electric vehicle (EV) of a plurality of EVs and location information associated with each EV of the plurality of EVs;
determine, based on the location information, for each EV of the plurality of EVs, a first rate for electricity consumption and a second rate for electricity consumption;
determine, based on the charging information associated with each EV of the plurality of EVs, an amount of electricity consumption associated with the EV; and
update an account associated with each EV of the plurality of EVs, wherein the updated account indicates a payment amount for an amount of electricity consumed at the first rate and a payment amount for the amount of electricity consumed associated with the EV at the second rate.

19. The apparatus of claim 18, wherein the processor-executable instructions that cause the apparatus to receive the charging information associated with each EV of the plurality of EVs further cause the apparatus to receive the charging information from a plurality of charging stations, wherein each charging station of the plurality of charging stations is associated with a location of a plurality of locations indicated by the location information.

20. The apparatus of claim 18, wherein the charging information associated with each EV of the plurality of EVs is in a format associated with a manufacturer of a charging station of a plurality of charging stations, wherein each charging station of the plurality of charging stations is associated with a location of a plurality of locations indicated by the location information, the method further comprising converting, for the charging information associated with each EV of the plurality of EVs, based on a conversion protocol, the format associated with the manufacturer to a second format.
